(19) United States
(12) Patent Application Publication
(10) Pub. No.: US 2017/0177590 A1
(43) Pub. Date: Jun. 22, 2017

(54) NATURAL CLASSIFICATION OF CONTENT USING UNSUPERVISED LEARNING

(71) Applicant: Qbeats Inc., New York, NY (US)

(72) Inventor: Boris Akselrud, Hightstown, NJ (US)

(21) Appl. No.: 15/381,204

(22) Filed: Dec. 16, 2016

Related U.S. Application Data
(60) Provisional application No. 62/269,868, filed on Dec. 18, 2015.

(51) Int. Cl. G06F 17/30

(52) U.S. Cl. CPC G06F 17/3071; G06F 17/30675

(57) ABSTRACT

Rating a plurality of digital content items accessible via a network based on consumer interest, including continuously at predetermined intervals identifying a plurality of digital content items discoverable via the network and having dynamic characteristics of temporal behavior of an active conversation; grouping the identified plurality of digital content items into a plurality of event centers, each including one or more word cliques focused on a shared event, each word clique consisting of a unique plurality of words identified in a subset of a plurality of digital content items; rating the event center identified during an initial calculation of the predetermined intervals in accordance with a known value of subject matter related to the shared event; and subsequently, rating the digital content items comprising the one or more word cliques of the event center by correcting the rating set during the initial calculation based on gain and loss in an amount of the plurality of digital content items related to the shared event.

### CROSS-REFERENCE TO RELATED APPLICATIONS

This application claims priority to U.S. Provisional Patent Application Ser. No. 62/269,868, entitled “NATURAL CLASSIFICATION OF CONTENT USING UNSUPERVISED LEARNING” and filed Dec. 18, 2015, the disclosure of which is incorporated herein by reference in its entirety.

### FIELD OF INVENTION

The present system relates to discovering, classifying individual digital content items and rating them in comparison to each other and/or with regard to interest of consumers in their subject matter.

### BACKGROUND OF INVENTION

The sheer amount and diversity of things in the world, organic and inorganic, natural and man-made defies human ability to remember and to recall them. To help keep track of things people use classification. Some practical attempts at classification are described in the Bible, for example, waters were separated from dry land, days were classified into weeks, animals were classified by names, the languages were classified or distinguished, i.e., in Babel, etc. More recently, a branch of science called Taxonomy was developed specifically to classify, categorize, order, and distinguish. Taxonomy is applied in many fields, e.g., Geology, Geography, Linguistics, Zoology, etc. For example, in Zoology and related sciences all living things are classified hierarchically in accordance with the following classes or categories: Kingdom; Phyla; Classes; Orders; Families; Genera (genus); and Species. Similarly, classification of subject matter of printed content, e.g., books, texts, magazines, and etc., traces its roots to the middle to late 19^{th} century when, Dewey Decimal Classification (DDC), a hierarchical system for organizing Books, was developed. As currently utilized, this system uses ten top level classes, each of which is divided into topical subdivisions.

The living things and the subject matter of the printed content categorized hierarchically by Taxonomy and DDC remain relatively stable and generally do not require changes to their classes and categories. For example, when new species of frogs, birds, and other live organisms are discovered, they are neatly classified within the existing Taxonomy and when the printed content is produced that is focused on new, previously unknown subject matter, or by new, previously unpublished authors, DDC is adept to deal with this.

### Digital Content

Disappointingly, no overarching classification has yet been adapted to categorize the subject matter of digital content, e.g., digital content items accessible via the Internet. While websites or computers that host the digital content items like webpages can be said to be classified by their uniform resource locator (URL) addresses or their name extensions, e.g., .com; .ru; .co. it; .gov; .org; .info; .sale; .online; and others, the digital content of their webpages is nonconforming. Moreover, in view of a wide diversity of the subject matter and immense daily increases in the amount of the digital content accessible via the Internet, even these sectors in which classification exists, as will be discussed below, cannot correctly and/or automatically create new classifications to account for new subject matter or new focus within existing subject matter. This inability to classify negatively affects discovery of individual digital content items in particular and groups of digital content within a given subject matter in general. For the same reason, because of deficiency of organization of the subject matter on the Internet, individual content items cannot be rated in comparison to each other and/or with regard to interest of consumers in their subject matter.

As stated above, a small portion of the digital content on the Internet is categorized. Library websites, for example, use DDC, and rely on shared characteristics of their book content, e.g., International Standard Book Number (ISBN); Publishers' names; genre, i.e., novel, drama, comedy, fiction, etc. Similarly, news providers and aggregators like the New York Times, Google News, Yahoo News, Huffington Post, etc., classify individual news and human interest articles e.g., using subject indexing and taxonomies of the International Press Telecommunications Council (IPTC) into classifications.

Such classifications may include: News of the World; Politics; Business; Opinion; Technology; Science; Health; Sports; Arts; Style; Food; Travel; and Real Estate, and more. However, these classifications are linear, non-hierarchical and therefore deficient in that all the news content is sorted into the existing classifications thereby any new subject matter is mixed in to not-relevant classes. Further, because classes include content items with varying unaccountable degrees of adherence to the subject matter, these items cannot be rated in comparison to each other and/or with regard to interest of consumers in their subject matter.

Further, the news content items are classified manually by humans who identify them as belonging to one of the specific IPTC classes while the news content items are produced or by reading the content. Alternatively, the news content items may be classified automatically by a computer using, e.g., Term Frequency-Inverse Document Frequency (TF-IDF) computer algorithms. TF-IDF algorithms compare words repeating in the news content item with a certain frequency to a collection of words identified as belonging to one of the news classes, e.g., IPTC. In TF-IDF the determination is achieved by finding a value for a word or term. This value increases proportionally to the number of times that word or term appears in the content and is offset by the frequency of the word or term in a collection of stories associated with the class. Thus, a class of the news content item is determined by a number of times the word or term from the news item is found in a predetermined subset of stories known to belong to a specific class.

Thus, it is precisely because TF-IDF requires a comparison to the existing content in an existing class, new classifications cannot form automatically. This is why sometimes the “Archeology” section in Google News features news stories on excavation of subway tunnels. Worse yet, is when stories do not fit existing classifications the fall by wayside, and are not discoverable at all. It is not knowable how many content items are not discoverable because they are not classified or because they do not use any of the terms proscribed by the TF-IDF. Because of this, immense amounts of information on the Internet are found and no one is made aware of its existence. It is understood that these content items cannot be rated or judged with regard to interest of consumers in their subject matter.

Access to unclassified digital content items on the Internet can be described as stripping all the DDC identifiers from the library books, which on the Internet also include articles, posts, blogs, forums, tweets, etc., and shuffling them.

### SUMMARY OF INVENTION

It is an object of this invention to provide a method and a system for automatic, unsupervised classification of digital content items that does not involve the use of TF-IDF and/or TF-IDF algorithms.

It is a further object of this invention to provide a method and a system for automatic, determination of evolution of interest in events reflected in the digital content having the subject matter of the respective event.

Provided is a method of rating a plurality of digital content items accessible via a network based on consumer interest, including continuously at predetermined intervals identifying a plurality of digital content items discoverable via the network and having dynamic characteristics of temporal behavior of an active conversation; grouping the identified plurality of digital content items into a plurality of event centers, each including one or more word cliques focused on a shared event, each word clique consisting of a unique plurality of words identified in a subset of a plurality of digital content items; rating the event center identified during an initial calculation of the predetermined intervals in accordance with a known value of subject matter related to the shared event; and subsequently, rating the digital content items comprising the one or more word cliques of the event center by correcting the rating set during the initial calculation based on gain and loss in an amount of the plurality of digital content items related to the shared event.

### BRIEF DESCRIPTION OF DRAWINGS

The invention is explained in further detail, and by way of example, with reference to the accompanying drawings wherein:

FIG. 1 is a flowchart diagram illustrating processing performed by a crawler process in accordance with the present system;

FIG. 2 is a flowchart diagram illustrating processing performed by a word clique combiner process in accordance with the present system;

FIG. 3a is a diagram of a matrix of selected documents by all significant words in all the selected documents in accordance with the present system;

FIG. 3b is a diagram of a similarity coefficient matrix of words in the matrix of FIG. 3a in accordance with the present system;

FIGS. 3c and 3d are diagrams of filtered G matrixes of K matrix of FIG. 3b using different thresholds or times in accordance with the present system;

FIG. 3e is a diagram indicating that word cliques at smaller threshold are included within word cliques at greater threshold in accordance with the present system;

FIG. 4a is a diagram of a matrix of word cliques in all the G matrixes of FIG. 3d by all words in the word cliques in accordance with the present system;

FIG. 4b is a diagram showing a similarity coefficient matrix Q of word cliques in the matrix C of FIG. 4a in accordance with the present system;

FIG. 5 is a flowchart diagram illustrating processing performed by a word clique classifier process in accordance with the present system;

FIG. 6a is a diagram showing an example of word cliques having predetermined number of words in common in accordance with the present system;

FIG. 6b is a diagram showing clusters of related word cliques in accordance with the present system;

FIG. 6c is a bar graph showing a number of connected components for each threshold or filtering parameter in accordance with the present system; and

FIG. 7 is a diagram illustrating the components making up computing devices for performance of steps in accordance with the preferred embodiment.

### DETAILED DESCRIPTION OF INVENTION

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

At the outset, it is submitted that any type of a meaningful human discussion or an exchange of opinions about some event between more than two people has a concise focus known to the participants of the discussion. Such discussion is meaningful vis-à-vis the focus. Over time, this meaningfulness appears, builds up and disappears from the public interest, hence “Transient Meaning”. Any cryptic discussion which does not disclose such focus is meritless. Therefore, after discarding all “notes to self” and person to person communications between pairs of people with intimate knowledge of the focus of the discussion, where there is no need to convey the focus, all other discussions will have a discernable focus.

The digital content items accessible via the Internet, i.e., News articles, editorials, blogs, tweets, etc., can be considered such discussions with known focus. Accordingly, if, with a certain degree of precision, parameters can be established to identify the focus, these parameters can be used at the time of execution to identify all content items having thus identified focus within a certain set of the content items, e.g., Rich Site Summary (RSS) news feed, a subset of content items accessible via some network, or all of the content items accessible via the Internet.

### Word Cliques

Thus, to categorize content items by focus and, thereby achieve the objects of the invention, it is proposed to use an unsupervised algorithm that operates on the content items accessible via the Internet, any other network or locally. The content items may comprise text, images, audio, and video, in a wide range of topics and subjects. For example, the content items may include news articles, discussion on topics of interest, exchanges of opinions in all possible specific areas found for example in blogs, tweets and on the Internet forums. These content items possess concise or real meaning to the consumers.

The meaning is expressed by certain words found within the content item and is directed toward a unique focus, i.e., topic. Put in other way, the content is meaningful in relation to the focus. It is understood that each content item may have more than one meaning and therefore more than one focus. Thus, a story about head injuries in football is a story about “Sport” and about “Health”. The words of the content item that express the meaning are called word cliques. A word clique is described as a group of words that is persistently used in content on the same subject. The words in the word clique are found together in documents on the same topic more regularly than others. A subset of the content items may share a unique focus, yet each of the content items may have their meaning expressed by a different word clique. It is further noted that over time, a correlation between the word cliques is characterized by an appearance, rise and decline of the common focus. Different word cliques having the same focus do not use the same words, in other words use of same or similar words is not required to express the same focus.

### Crawler

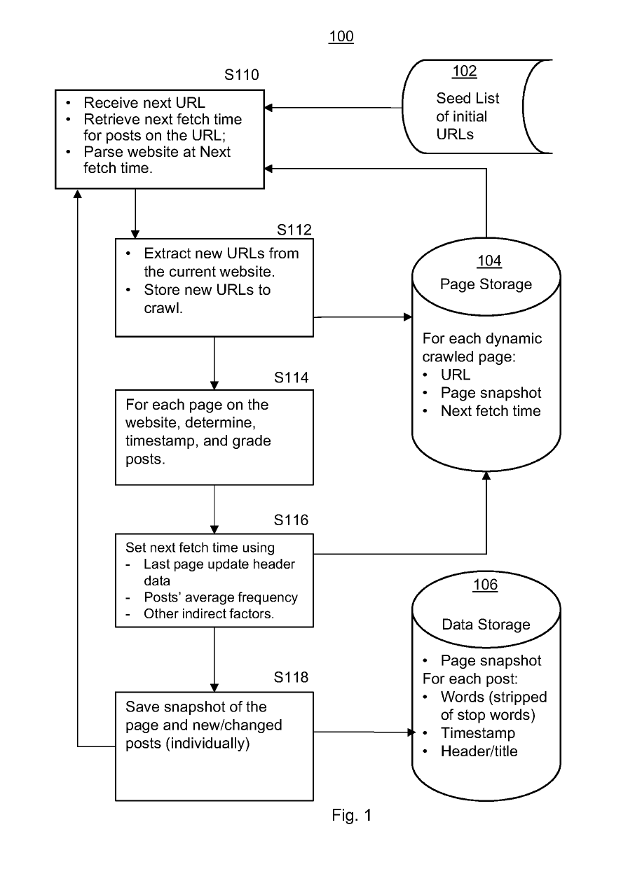

To classify the content items, (1) the content items must be discovered; (2) the meaning of each discovered content item must be expressed in the word cliques; and (3) the focus of the word clique content items must be discerned. The discovery of the content items is achieved by finding all content items stored on computer readable media that is stand-alone or accessible via the network. As indicated above the content items may be RSS news feed or some subset accessible via the Internet. For example, as illustrated in FIG. 1, a real-time crawler 100, e.g., a variation of Apache's Nutch, may be used. Crawler 100 may include multiple iterations performing similar or different crawling tasks. For, this discussion, the content items are exemplified by separate articles or posts posted on webpages hosted on websites having known or discoverable URL addresses. For reasons discussed above, it is necessary to know if the content is dynamic. This is because the correlation between the word cliques and the focus appears, rises and declines over time, such correlation is cannot be expressed in the static content. Therefore, the static content must be ignored. Crawler 100 will capture the dynamic content items while ignoring the static content. The dynamism of the individual posts is determined by contrasting timestamps of individual posts and the absolute date of the webpage on which the posts or articles are posted. A difference between the two timestamps determines a frequency at which the webpage is updated or its refresh rate.

At step S110 crawler 100 commences parsing of the websites. For the initial run, URL addresses for the websites to be parsed are provided in seed list 102. After the initial run, as explained below, URL addresses are found in Page database 104. It will be appreciated by these skilled in the art that a breadth or inclusiveness of the crawl can be controlled by later-determined or pre-determined characteristics of the websites. For example, once the rate of interest of consumers in the subject matter having a particular focus is determined, seed list 102 and/or Page database 104 can provide crawler 100 with URL addresses of the websites known to focus on the subject matter having characteristics of the rated consumer interest. At step S112, each addressed website is parsed; all URL addresses on the website are retrieved and stored in Page database 104. As indicated above, the stored URL addresses can be subsequently used in step S110 instead of the initial URL addresses from seed list 102.

At step S114, crawler 100 (1) parses the website to determine existence of different pages and distinctive posts on these pages; (2) if any posts exist, takes a snapshot of the page having the post; divides the snapshot into post blocks, each having a header; timestamps the page and each post; and grades each the page and each post based on conventional and other indirect factors.

At step S116 the next fetch time to parse the current page is set based, e.g., on an average frequency at which the posts on the page are updated and stored in Page database 104 together with the snapshot of the page and the URL of its website.

At step S118, the snapshot extracted in step S114 and enhanced with the timestamp and the grade for the page and individual posts is stored in crawled Word database 106. Importantly words from each post are also stored. These words are processed to only include meaningful words, which do not include “stop words”, e.g., the, is, that, etc., which must be filtered out prior to formation of the matrixes discussed below. Additional filtering out or paring down of the words may be achieved based on string frequency approaches, i.e., words used in the document fewer times than provided by a predetermined threshold are filtered out or removed.

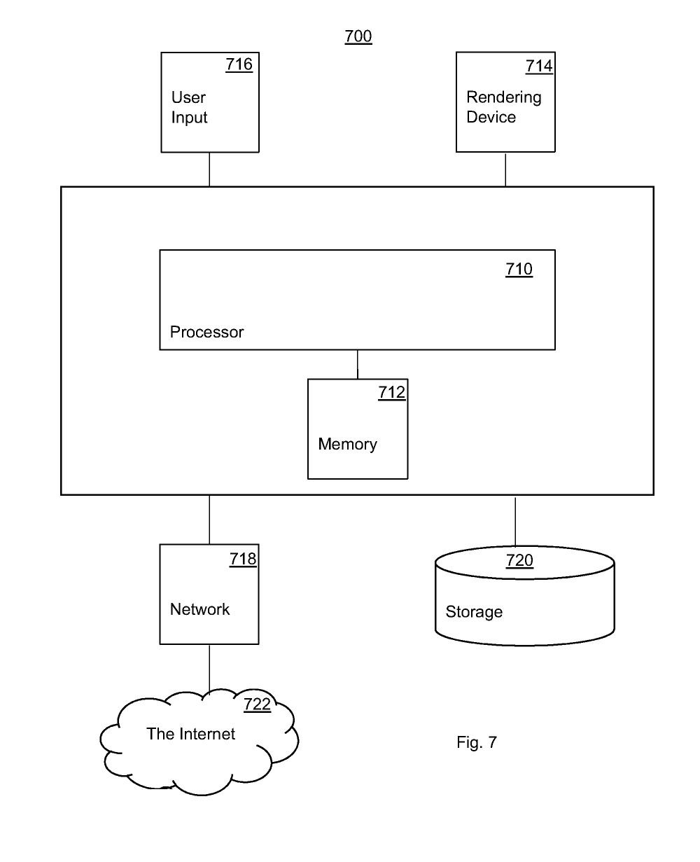

It will be clear to these skilled in the art that programming and execution of crawler process 100 (FIG. 1) can be achieved on a general purpose computer processing device such as described below with reference to FIG. 7 using Internet Archive's Heritrix, Apache's Nutch, Jspider from sourceforge.net and general-purpose computer languages, e.g., standard Java, and utilizing open source libraries, e.g., SUTime from Stanford.edu and/or their analogues. In addition open source database MongoDB from mongodb.org and related libraries and/or their analogues can be used to store and manage crawled data.

### Combiner

After its initial run parsing websites having URL addresses referenced in seed list 102 and continuous subsequent runs that rely on additional URL addresses collected in Page database 104, crawler 100 accumulates a vast number of dynamic timestamped posts in Word database 106. As discussed, the posts, which are addressed below as documents, are stripped of stop words and low frequency words. As shown in FIG. 2, the accumulated documents and words comprising them are processed and classified by combiner process 200. In step S202, combiner process 200 is executed at predetermined intervals which may be tuned to accommodate best results based on arrival of new documents into Word database 106 or simply every N-minutes. The documents processed commonly include all documents that have not been previously processed or all documents for specific timeframe.

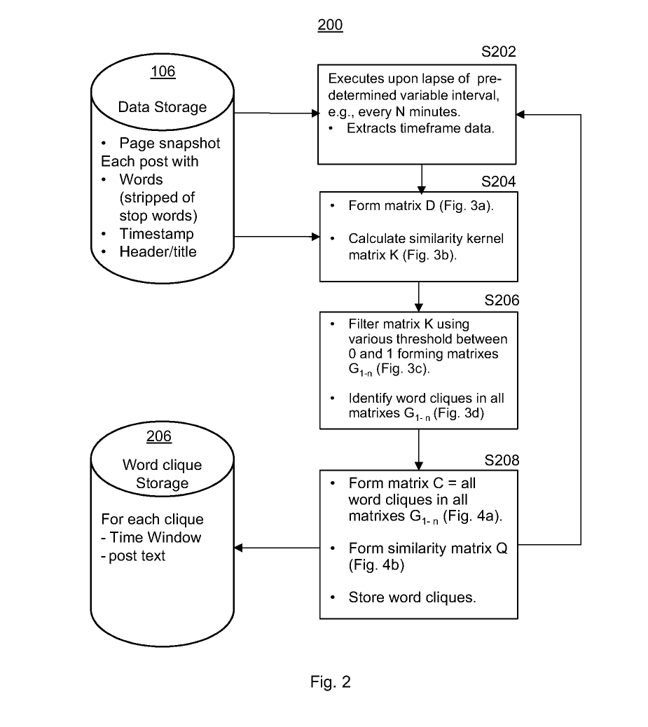

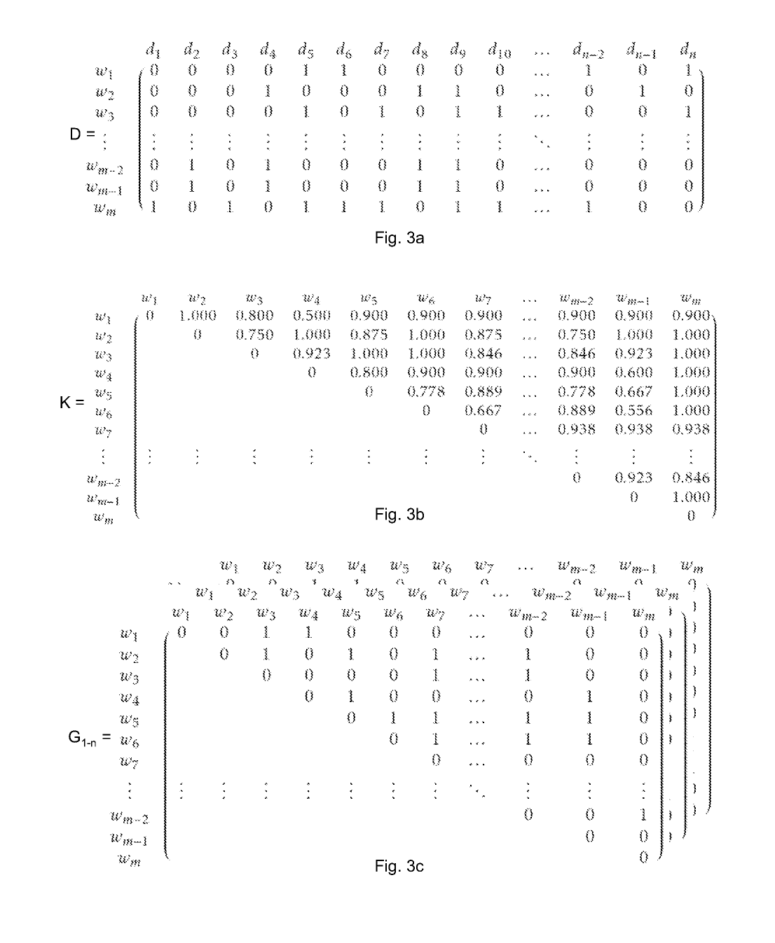

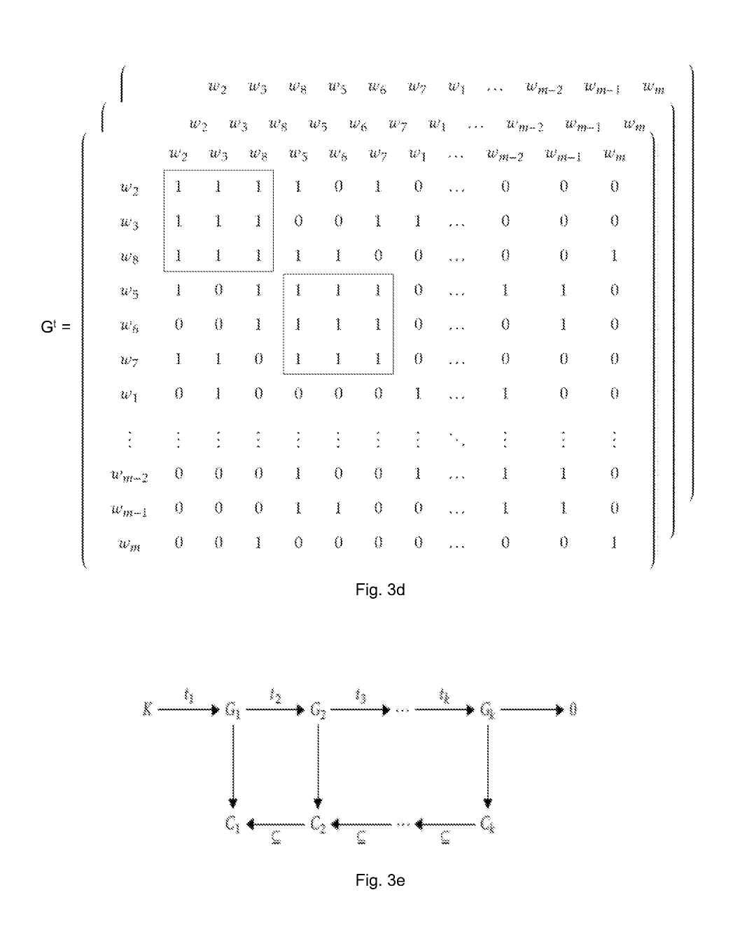

In step S204, combiner process 200 (1) retrieves the documents having the timeframe range extracted in step S202 and all their respective words from Word database 106; (2) forms sparse matrix D, an example of which is illustrated in FIGS. 3a; and (3) transform matrix D into kernel matrix K, an example of which is illustrated in FIG. 3b, based on similarity between words in matrix D. In its first dimension matrix D includes a list of all documents, i.e., d₁-dₙ, and in the other dimension, a list of all meaningful words found in all the listed documents, i.e., w₁-wₘ, where values D_{i,j} for rows i and columns j are either 0 or 1 indicating the presence of the words in the documents such that their presence is set to 1 and absence is set to 0. It is noted that the list of documents may be optionally limited to a certain subset of the documents.

In its first and second dimensions matrix K includes the words found in matrix D, where values Kᵢⱼ for rows i and columns j are real numbers between 0 and 1 indicating the level of similarity between the words found in the documents such that their intersection along the diagonal of the matrix is set to 0. This transformation can be realized using, for example, Jaccard similarity coefficient, which compares the similarity and divergence of sample sets and measures similarity between finite sample sets.

Further, in step S206, combiner process 200 filters the matrix K using a plurality of various thresholds (t), such that values Kᵢⱼ that are equal to or above t are set to 1 and these below t are set to 0. This filtration process forms a plurality of respective dense matrixes G₁₋ₙ, which may be represented as follows: G^{t0}⊂G^{t1}⊂G^{t2} . . . ⊂G^{tk}; tₖ∈(0 . . . 1).

In other words, word intersections G^{t}ᵢⱼ=1, found in matrixes with larger threshold (t), are included in matrixes with lesser threshold (t). ( ) The result is illustrated in FIG. 3c where matrixes G are displayed. Topological features of all the dense matrixes G^{t} at different spatial resolutions can be computed, e.g., by using persistent homology. Specifically, as shown in FIG. 3d, in each matrix G^{t}, groups of words, e.g., as outlined by a rectangular border and including (w₂, w₃, and w₈) and (w₅, w₆, and w₇) form word cliques, which are grouped together along the diagonal of the matrix G.

Additionally, as shown in FIG. 3e, as the threshold (t) decreases word cliques in sets with smaller threshold (t) are subsets of the word cliques in sets with the larger threshold. This is represented as: C*=∪Cₖ.

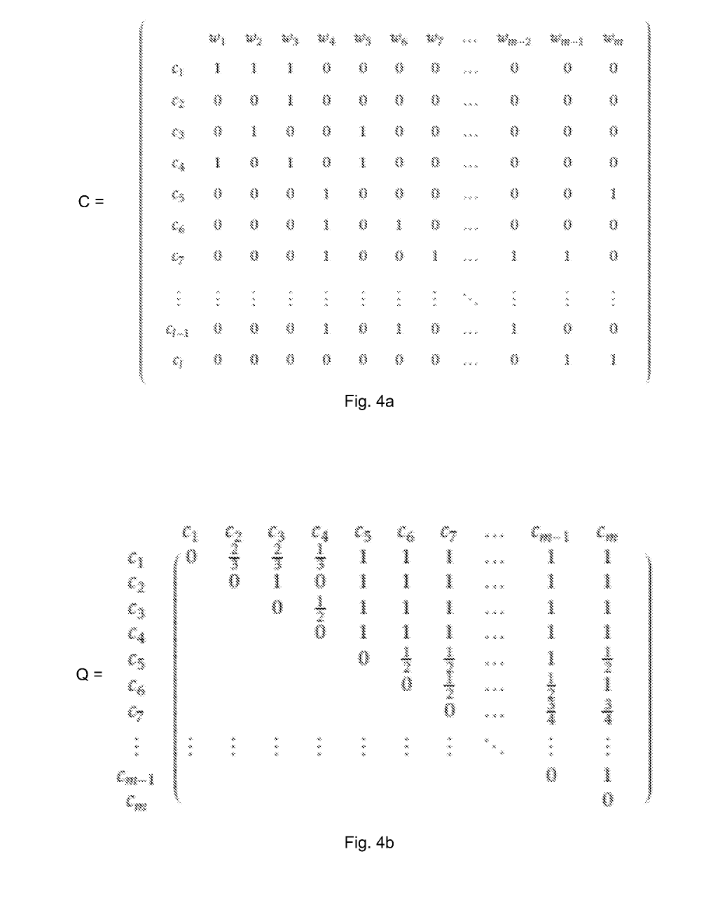

Once the word cliques are determined as described-above and illustrated in FIG. 3d, a matrix C, e.g., illustrated in FIG. 4a, is formed having in a first dimensions a list of all word cliques, i.e., found at each of the thresholds (t) in all matrixes G^{t} (FIG. 3d) and in the other dimension all words found in all the listed word cliques, i.e., w₁-wₘ.

Returning now to FIG. 2., in step S208 square similarity matrix Q, illustrated in FIG. 4b is formed having a list of all word cliques, i.e., c₁-cₙ, in its first and second dimensions, such that values Q_{i,j} for rows i and columns j indicate the level of similarity between the words forming the word cliques and their intersection along the diagonal of the matrix is 0. This transformation can also be realized using similarity coefficient, e.g., Jaccard similarity coefficient.

All the word cliques for a predetermined interval discussed above with reference to step S202 are then stored in database 206. Additional information associated and stored with the individual word clique in database 206 includes the words producing the word clique; documents or references to documents having the focus characterized by the word clique; the interval, i.e., start and end times of formation of the word clique which is within the predetermined interval; and a reference number that uniquely identifies the word clique. Then combiner process 200 returns to step S202, and repeats the execution at expiration of the predetermined interval.

It will be clear to these skilled in the art that programming and execution of combiner process 200 (FIG. 2) can be achieved on a general purpose computer processing device such as described below with reference to FIG. 7 using most general-purpose computer languages, e.g., Java, Python, Scala, and utilizing open source libraries, e.g., sciPy from sciPy.org, numPy from numPy.org, pandas and networkx from python.org and/or their analogues. In addition, as discussed above open source database MongoDB from mongodb.org and related libraries and/or their analogues can be used to store and manage the word cliques and any related data.

### Classifier

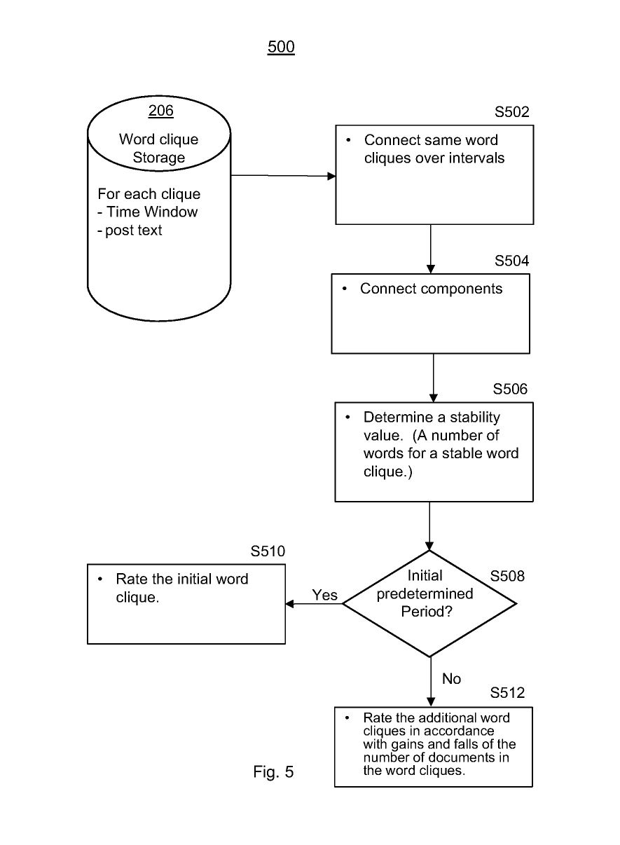

It is noted, as shown in FIG. 3e, that word cliques in sets with smaller threshold (t) are subsets of the word cliques in sets with the larger threshold. Furthermore, the discussion above specified the predetermined interval for execution of a single iteration of combiner process 200. Thus it should be appreciated that the word cliques may or may not continue across the periods. Accordingly, classifier process 500 shown in FIG. 5 in step S502 retrieves the word cliques and connects these having the same uniquely identifying reference number that is used to identify the same word clique over the time periods.

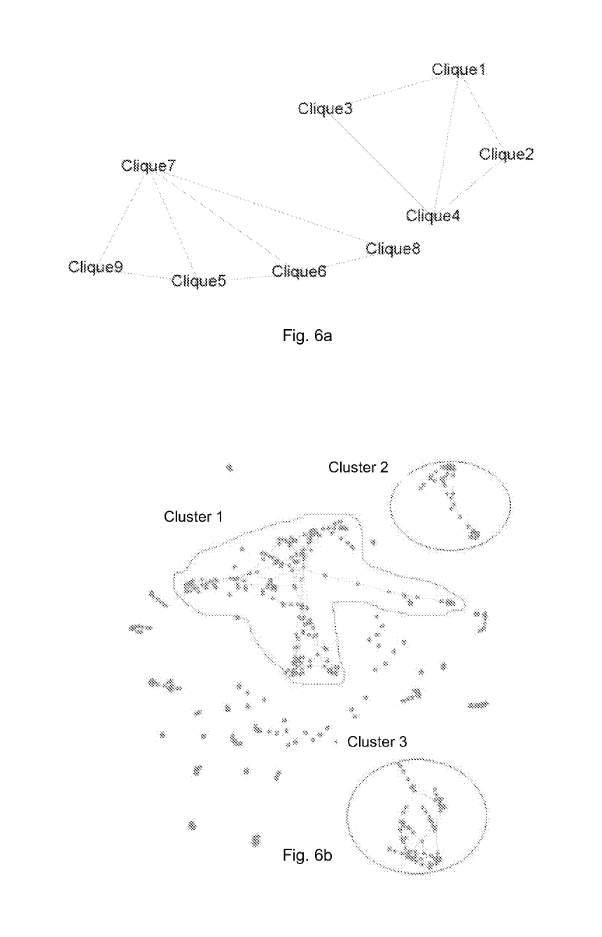

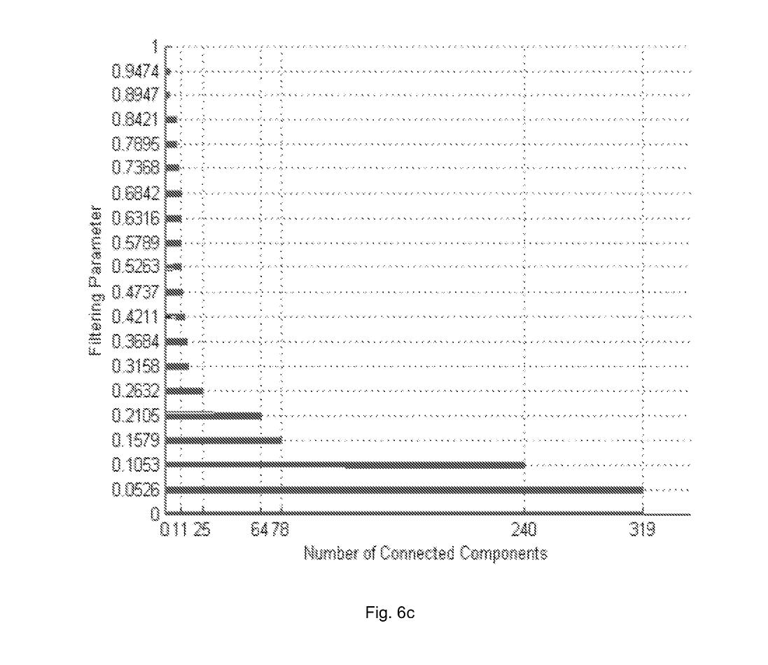

In step S504 a relationship between the word cliques as connected components may be constructed using values Q_{i,j}, as for example shown in FIG. 6a. The connectivity between the word cliques is based on inclusion of one or more similar words. As illustrated in FIG. 6b connected word cliques having same words will tend to cluster as shown with clusters 1, 2, and 3. Such clustering indicate news events.

In step S506, using values Q_{i,j} from matrix Q (FIG. 4b) a graph, illustrated in FIG. 6c, of number of connected components between the values of 0 and 1 can be constructed for each of the clusters or events. Evaluation of the graph will reveal an area in which the number of connected components is stable. In an example of the graph of FIG. 6c such stable area appears between values 0.6842 and 0.4737. The values identify the stable area and are used to select the word cliques in the matrix Q (FIG. 4b) which reliably or consistently maintain the focus of the documents. In other words, the documents having the same focus are represented by these word cliques.

At step S508 classifier process 500 determines if current is the initial execution of step S202 (FIG. 2). If it is, in step S510 the word clique is rated in accordance with any known method of rating content. If on the other hand, the current word clique has been previously rated, then in step S512 each of the documents of the current execution of step S202 (FIG. 2) are rated by correcting the rating set in step S510 in accordance with gains and falls of the number of documents within the word cliques.

It will be clear to these skilled in the art that programming and execution of classifier process 500 (FIG. 5) can be achieved on a general purpose computer processing device such as described below with reference to FIG. 7 using most general-purpose computer languages and open source databases and/or their analogues can be used to store and manage the word cliques and any related data.

### Processor

FIG. 7 shows a system 700 which represents an example of a computing device utilized to implement and execute crawler, combiner, and classifier programs discussed above with reference to FIGS. 1, 2 and 5. One or more systems 700 may be used to execute the above-discussed programs. Similarly, it will be apparent to these skilled in the art that each of these programs may be subdivided into separate discrete units of programming code. Any bundling of these units is done to simplify the narrative of this discussion.

The system 700 includes a processor 710 operationally coupled to a memory 712, an optional rendering device 714, such as one or more of a display terminals, one or more user input devices 716, a network interface 718 connectable via wired or wireless means to a network 722, e.g., the Internet, and optionally a local storage 720. The user input 716 may include a keyboard, mouse or other devices including touch sensitive displays communicating with the processor 710 via any type of link, such as a wired or wireless link. The user input device 716 is operable for interacting with the processor 710 including interaction within a paradigm of a UI such as a GUI and/or other elements of the present system, such as to enable web browsing, content selection, such as provided by left and right clicking on a device, a mouse-over, pop-up menu, radio button, etc., such as provided by user interaction with a computer mouse, etc., as may be readily appreciated by a person of ordinary skill in the art. Thus it is clear that the processor 710, memory 712, optional rendering device 714, user input device 716, and network adapter 718 may be portions of a computer system or other device.

The storage 720 may be any fixed or removable computer-readable medium, e.g., ROM and RAM, CD-ROM, hard drives, or memory cards. Any medium known or developed that may store and/or transmit information suitable for use with the computer system may be used as the computer-readable medium. Such computer-readable medium may be used to store all the above discussed programs for execution by processor 710. The network adapter 718 should be understood to include further network connections to other user devices, systems, e.g., routers, modems, etc. While not shown for purposes of simplifying the description, it is readily appreciated that the network adapter 718 may include an operable interconnection between networked processors, which may host websites.

### Provisions

While the present system has been described with reference to exemplary embodiments, it should also be appreciated that numerous modifications and alternative embodiments may be devised by those having ordinary skill in the art without departing from the broader and intended spirit and scope of the present system as set forth in the claims that follow.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a. the word “comprising” does not exclude the presence of other elements or acts than those listed in a given claim;
b. the word “a” or “an” preceding an element does not exclude the presence of a plurality of such elements;
c. any reference signs in the claims do not limit their scope;
d. several “means” may be represented by the same item or hardware or software implemented structure or function;
e. any of the disclosed elements may be comprised of hardware portions (e.g., including discrete and integrated electronic circuitry), software portions (e.g., computer programming), and any combination thereof;
f. hardware portions may be comprised of one or both of analog and digital to portions;
g. any of the disclosed devices, portions thereof, acts, etc., may be combined together or separated into further portions, acts, etc., unless specifically stated otherwise;
h. no specific sequence of acts or steps is intended to be required including an is order of acts or steps indicated within a flow diagram; and
i. the term “plurality of” an element includes two or more of the claimed element, and does not imply any particular range of number of elements; that is, a plurality of elements may be as few as two elements, and may include an immeasurable number of elements.

What is claimed is:

1. A method of rating a plurality of digital content items accessible via a network based on consumer interest, the method comprising acts of:
continuously at predetermined intervals identifying a plurality of digital content items discoverable via the network and having dynamic characteristics of temporal behavior of an active conversation;
grouping the identified plurality of digital content items into a plurality of event centers, each including one or more word cliques focused on a shared event, each word clique consisting of a unique plurality of words identified in a subset of a plurality of digital content items;
rating the event center identified during an initial calculation of the predetermined intervals in accordance with a known value of subject matter related to the shared event; and
subsequently, rating the digital content items comprising the one or more word cliques of the event center by correcting the rating set during the initial calculation based on gain and loss in an amount of the plurality of digital content items related to the shared event.

2. The method of claim 1, wherein the dynamic characteristics include appearance, rise, fall and disappearance of interest in subject matter of the active conversation.

3. The method of claim 1, further comprising an act of aggregating the characteristics of temporal behavior of one or more word cliques.
